(19) United States
(12) Patent Application Publication
(10) Pub. No.: US 2009/0258735 A1
(43) Pub. Date: Oct. 15, 2009

(54) Collapsible Sports Goal

(76) Inventor: Kevin Nash, Bonita, CA (US)

Correspondence Address: John Karl Buche;BUCHE & ASSOCIATES, P.C., 875 PROSPECT, SUITE 305, LA JOLLA, CA, 92037, US

(21) Appl. No.: 12/406,920

(22) Filed: Mar. 18, 2009

Related U.S. Application Data
(63) Continuation-in-part of application No. 11/144,962, filed on Jun. 3, 2005.

(51) Int. Cl. A63B 63/04; B23P 11/00

(52) U.S. Cl. 473/478; 29/428

(57) ABSTRACT

Disclosed is a sports goal which telescopically collapses or expands in the vertical, horizontal, or longitudinal planes. Telescopic manipulation is facilitated via bearing systems on all telescoping components.

### CROSS-REFERENCE TO RELATED APPLICATIONS

The Following is a Continuation-In-Part of U.S. patent application Ser. No. 11/144,962 entitled “COLLAPSIBLE SPORTS GOAL” and filed Jun. 3, 2005, which disclosure is incorporated by reference as if fully set forth herein.

### STATEMENT REGARDING FEDERALLY SPONSORED RESEARCH OR DEVELOPMENT

Not applicable.

### BACKGROUND OF THE INVENTION

1. Field of the Invention

This invention relates generally to sports goals. More particularly the device disclosed herein relates to frame supported nets used in games to determine a score by catching a ball or puck. Goal frameworks for impromptu or official sporting events utilizing nets such as soccer and hockey employ a net supported by a metal frame which determines the aperture size for the ball or puck to pass through and be caught by the supported net.

More particularly the present invention refers to a multi-axis, telescopically collapsible and adjustable goal structure that can be easily erected and collapsed without tools within the vertical, horizontal and longitudinal axises; and, which provides for simple installation and removal, especially in temporary sporting situations in parks, yards, beaches and other areas. In the preferred embodiments to be described herein, the device is easily stored in the collapsed state and then easily repositioned on the sports field of play. The device can provide for permanent net attachment and may be used for different sports or games by adjusting the height, width and length of the structure through the use of interconnected telescoping crossbars.

As originally conceived, games such as hockey and soccer involving the use of a goal are played or practiced on an established, professionally maintained, permanent rink or playing field. In many informal situations, the generally flat surface of a playground, field, driveway, or street can also be used as a playing surface. In general, non-professional organized groups like schools, clubs and loosely knit amateur alliances must transport all of their own equipment, including one or more goal frames or structures, to and from the playing areas. This equipment also must be stored when not in use.

In many such sports contests, these goal markers, such as nets, are used to reference the place at which the team or player fulfills an action required to gain points in the contest. For example, Soccer, La Crosse and Hockey utilize suspended goal nets placed at opposing ends of the playing field into which the ball or puck is directed to signify the scoring of a point. When playing in an area specifically designed for such a contest, often permanently mounted goals are provided. Often though, permanent goal structures are unavailable for use such as in impromptu games in a park, games held when on the road, or for practice sessions where space, time and suitable conditions exist such as previously noted. Over the years many attempts have been made to create a simple, easily constructed and easily removable portable version of such a goal net, each with the intent to provide convenience, portability, compact storage and transport. As shall be seen, prior art has many examples that employ elegant mechanical connections requiring tools, others utilizing folding and swiveling structures and still others that use various clamps and insertable pins or rods for use and, as a result, all fall short of the primary goal of ease of use as shall be described below.

2. Description of Prior Art

U.S. Pat. No. 3,642,282 describes a foldable hockey goal with multiple front and rear bars attached to side and bottom bars through means of various clamps, pins, nuts and bolts and hinges and which requires tools for implementation. The most obvious shortfall of this design is the great likelihood during the excitement prior to the contest of the loss of any of the pins, bolts and other small pieces which would render the device unusable. In addition, even simple tools such as are employed for the assembly and disassembly may not be available at the time or place of use.

U.S. Pat. No. 4,116,446 depicts an apparatus for supporting nets to be used during different sporting events which utilizes U-shaped clips for net constraint, horizontally inter-engaging tubular rods attached to vertical rods which are designed to be driven into the ground and having transverse rods for additional rear support attached through means of wing nuts and bolts. This approach includes the shortfall of the prior design as it potentially requires the use of tools for assembly and has many small pieces that can be misplaced. The most significant flaw is the need for emplacement of the vertical support rods into the ground. In many areas such a practice may be precluded by local environmental laws and the use of such a device on a hard surface such as a parking lot would be rendered impossible without damage to the surface.

U.S. Pat. No. 4,702,478 indicates a collapsible goal frame having a detachable front crossbar and multiple upright, rear, side and lower members. The front crossbar which is held to the structure through multiple socket engagement can be disassembled into three separate components held together via an elastic cord that is threaded longitudinally through the separate components to provide tension. The uprights and horizontal cross members are telescoping components which are held together during use by spring loaded buttons which lock into corresponding holes in each piece. Transverse support is added through the use of triangular shaped corner gussets affixed to each corner with additional socket engagements. Hinges provide for the folding of the device during storage. Once again the use of such a methodology will be compromised through the loss of any of the multiple small pieces like the socket pins and triangular supports used to maintain the attachment and stability of the device. This is a fairly likely probability during the excitement of setup and disassembly prior to and subsequent to the performance of the sports contest. As a result this approach does not meet the necessary criteria of extended multiple long term use and re-use, easy transport and portability.

U.S. Pat. No. 6,209,878 outlines a portable soccer goal, the slidably connected components of which are held together in the proper sequence subsequent to assembly of the device for the event through the use of elastic cords. The assembled structure is removably affixed to the surface of the playing area through the use of cables attached to the device itself and to anchoring stakes which are then driven into the playing surface. Though this approach avoids the prior noted shortfalls in above noted designs, the need for anchoring stakes for affixation of the device to the playing surface precludes use on any but surfaces into which such anchoring stakes can be driven. Such a flaw would substantially reduce the effectiveness of the device as not all locations provide such surfaces or permit such anchoring stakes to be utilized, for example as in an asphalt parking lot or a tennis court.

U.S. Pat. No. 6,402,643 B1 describes folding soccer goal, consisting of a goalpost, backstay bars, and a net, wherein the goalpost has a horizontal crossbar and two vertical posts foldably attached to the crossbar; the backstay bars foldably attach to the goalpost and extend outward and downward therefrom; hinged foot assembly is connected to the bottom of each vertical post wherein the foot is adapted for attachment to a playing surface. Though this design avoids most of the disadvantages associated with the plurality of loose fasteners, hooks and clips and tools for driving or tightening the same and that may also become lost in transit or storage or during assembly of a goal on a turf playing field, the issue of physical attachment to the playing surface is not sufficiently addressed. As noted in the description of the device, the hinged feet may be attached to the playing surface by driving one or more spikes through each foot, or by inserting in the playing surface spikes that are an integral part of the foot. They may also be attached in several other ways including, on some surfaces, articulating with a permanent fastener integral with the playing surface.

As can be seen from the description, either a permanent fastener is required or a soft surface into which stakes or the pointed feet can be driven is required in order to affect proper utilization of the device and that is a defect for general impromptu use where such attributes are not present. Additionally, though the device is envisioned as being nominally adjustable for individual sports, as described sport specific sizes of the device would be required for each sport to be played. This would require multiple units to be available in order to switch between sports, an unnecessary complication in logistics.

U.S. Pat. No. 6,672,980 Sports Goal With Collapsible Frame denotes a portable hockey or soccer goal that can be readily converted between a fully open configuration and a fully closed storage or transport configuration without requiring any assembly or disassembly and having a rear and side stabilizing assembly such that the goal has improved strength while still being collapsible into a compact carrying bag. As illustrated in the drawings accompanying the application this device is composed of a number of swiveling, rotating and hinged folding components which permit the erection from a collapsed state to an extended-for-use configuration and with the process reversed for purposes of storage. The most obvious failing of this design is the likely high cost of manufacture and assembly of the three way swiveling and pivoting couplings which are key to the design. Additionally, the need for these components to slide, swivel and rotate combined with the plurality of hinged couplings required to affect proper extension introduces unnecessary complexity to the functional aspects of the design.

While it can be seen that the prior art in the field of portable sports goals is quite developed, it is the object of this invention to fulfill the need for a portable goal that: is telescopically collapsible in the horizontal, longitudinal, and vertical planes so that the goal can be stored in a minimal amount of space or area; does not require assembly or disassembly of component parts when it is being set up or broken down; and, at the same time, is sturdy or stable enough to withstand regular impacts commonly encountered during use. The present inventor has recognized this need and, after much trial and error, has developed a portable sports goal that is telescopically adjustable in the horizontal, longitudinal, and vertical planes so that the goal can be easily carried and will fit into a small vehicle.

In addition, no assembly of the component parts of the net or frame of the goal is required during set up or break down, which make the present sports goal significantly more attractive than prior art goals noted. The device will provide for net support through the utilization of at least one horizontal support member; the net support member having two parts composed of an insertion post and a receiving member, both adapted to allow the inserting post to smoothly translate within the receiving member.

The preferred embodiment would provide for additional horizontal supports. A preferred embodiment of the device will suitably collapse in at least two directions, substantially to ½ the expanded size and can be easily stored and set back up by simply extending the telescopically engaged horizontal, vertical, or longitudinal components to an expanded position from the collapsed position. The provision of spring actuated buttons or knobs to the telescopically engaged internal components and matching apertures in the external components as is noted in more detail below provides for expansion, collapse and movement control in all planes. While ordinarily a slidably and telescopically engaged device will have a tendency to remain in the expanded form when sitting on a field of play due to the effects of friction from the playing surface and the weight of the device, the same weight and friction prevents smooth transition from the collapsed to expanded configuration and vice versa. Accordingly, the provision of a bearing system at all telescoping connections as discussed below further provides for smooth expansion, collapse, and movement control in all planes.

All the horizontal members typically have a first member that is sized on the exterior to insertably engage in an axial cavity of a second horizontal member. All the vertical members would also have first members adapted in exterior circumference to engage within and telescope inside the axial cavity of the second members that translate over the first vertical members. The same suitably applies to longitudinal members.

While, as noted, friction of the components and the playing surface on the device can provide a means for affixing the relative positions of the components, such friction can hinder collapse and expansion of the device. Also, friction between telescoping members is exacerbated by a skew connection between inserting and receiving members. To combat such friction, whether from sliding or from a skew connection, a bearing system suitably is implemented at all inserting members which system interacts with the axial cavity of the receiving member so that telescoping is preferably accomplished via rolling rather than by member sliding. Because an expanded collapsible goal featuring a bearing system to reduce friction between telescoping connections can collapse under its own weight, the goal can preferably also be provided with a mechanical means of fixing and releasing from affixation the relative positions of the various telescopically engaged components. Such a means for affixing the components in place can be provided to the first and second members using a spring loaded depressible button switch or knob on the second member that would be biased toward the first member and engage in a corresponding aperture in the wall of the first member to hold the two members in the expanded position. Such apertures could be placed in multiple positions along the first member whereby adjusting the desired length, width, and height of the sections is permissible, as well as constraining any movement of the sections.

With respect to the above description, before explaining at least one preferred embodiment of the invention in detail, it is to be understood that the invention is not limited in its application to the details of construction and to the arrangement of the components or steps set forth in the following description or illustrated in the drawings, nor just to buildings. The apparatus and methods of the invention are capable of other embodiments and of being practiced and carried out in various ways which will be obvious to those skilled in the art once they review this disclosure. Also, it is to be understood that the phraseology and terminology employed herein are for the purpose of description and should not be regarded as limiting.

As such, those skilled in the art will appreciate that the conception, upon which this disclosure is based, may readily be utilized as a basis for designing of other structures, methods and systems for carrying out the several purposes of the present disclosed device. It is important, therefore, that the objects and claims be regarded as including such equivalent construction and methodology insofar as they do not depart from the spirit and scope of the present invention. Further objectives of this invention will be brought out in the following part of the specification, wherein detailed description is for the purpose of fully disclosing the invention without placing limitations thereon.

### BRIEF DESCRIPTION OF THE FIGURES

FIG. 1A displays an exploded view of a preferred embodiment of the device collapsible along two axises, which would be common to all embodiments having slidable engagements of horizontal and vertical members.

FIG. 1B depicts an exploded view of another preferred embodiment of the device collapsible along three axises employing the telescopic translating engagement of the other embodiments with base struts also being telescopic.

FIG. 2 depicts the device in an expanded position with net engaged.

FIG. 3 provides a perspective example of the device in a collapsed configuration where the net may remain engaged.

FIG. 4 depicts an example of a locking mechanism for the translating members of the device if employed.

FIGS. 5A and 5B depict a cross sectioned and profiled example, respectively, of a bearing system to facilitate the translating/telescoping of the device.

FIGS. 6A through 6H depict some of the differing configurations which the telescopic sports goal of this application can achieve via telescoping in the horizontal, vertical, or longitudinal planes/axises.

### DETAILED DESCRIPTION OF PREFFERED EMBODIMENTS

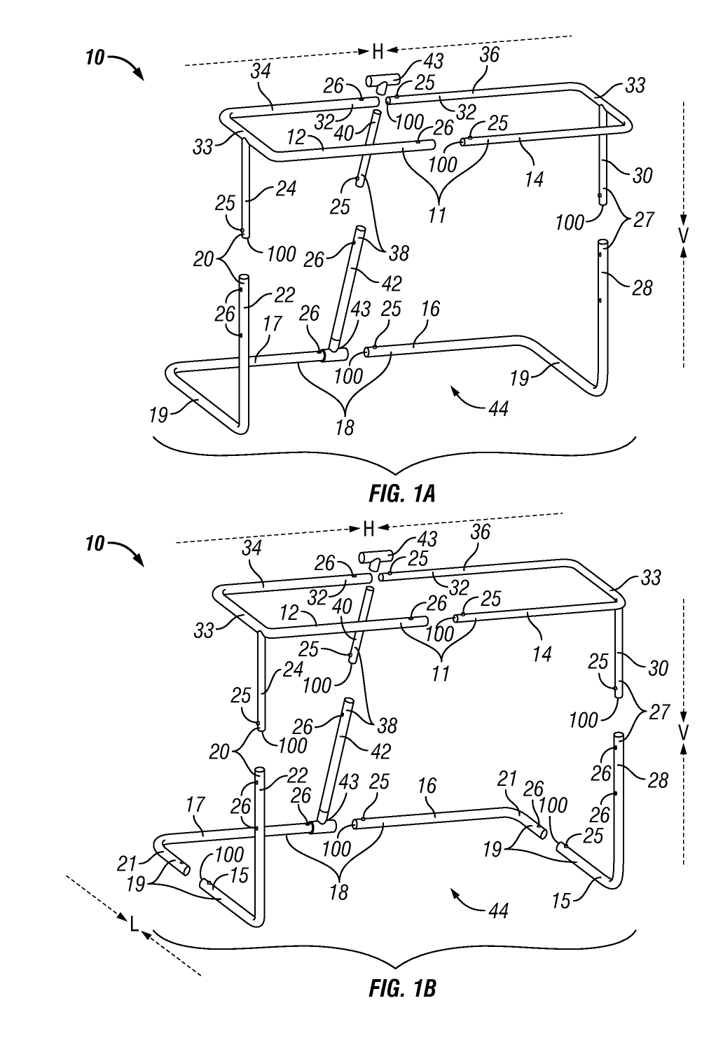

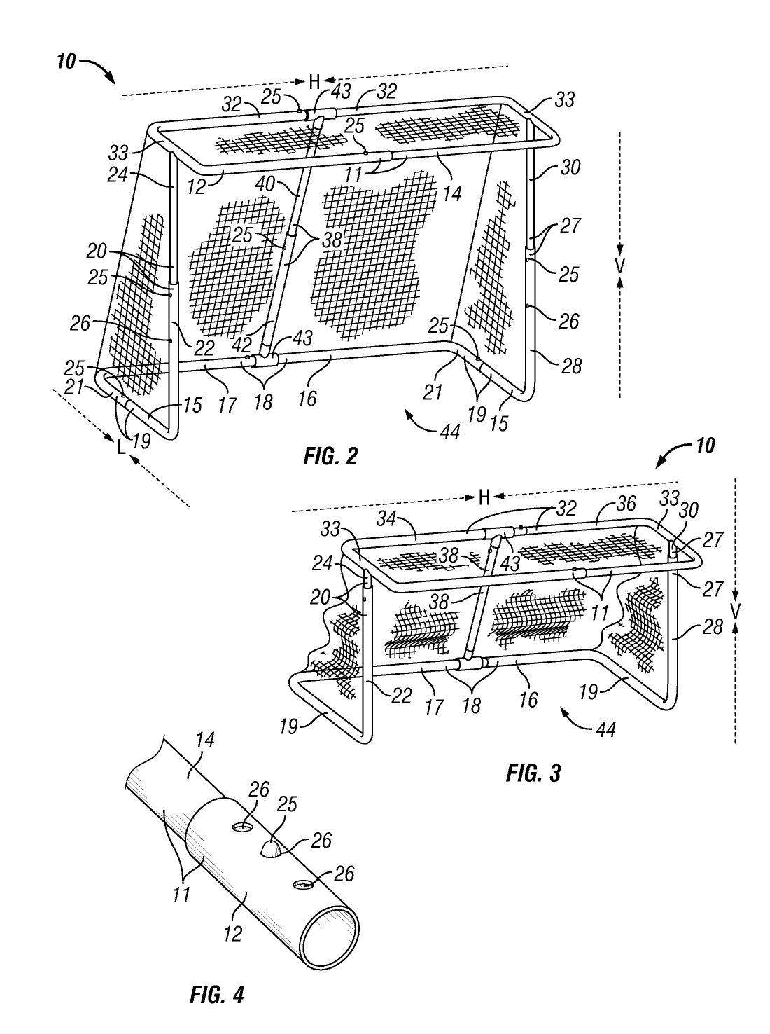

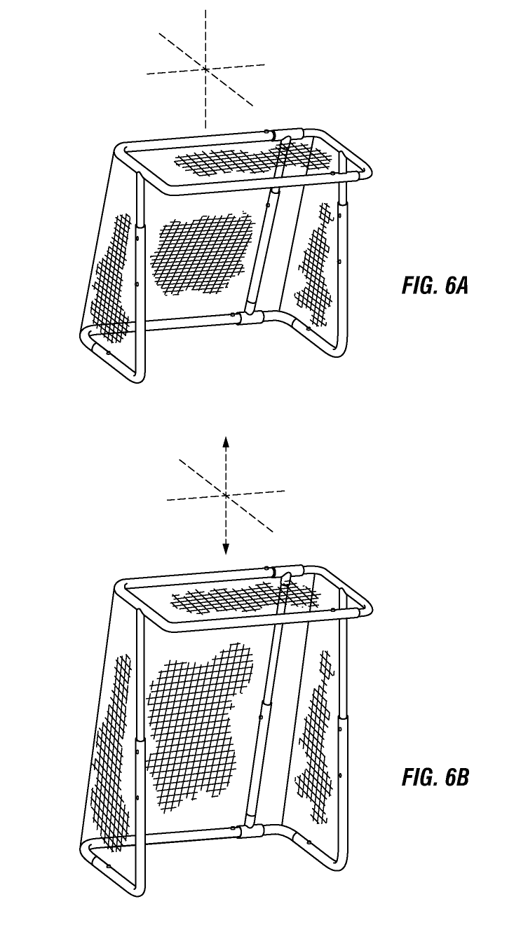

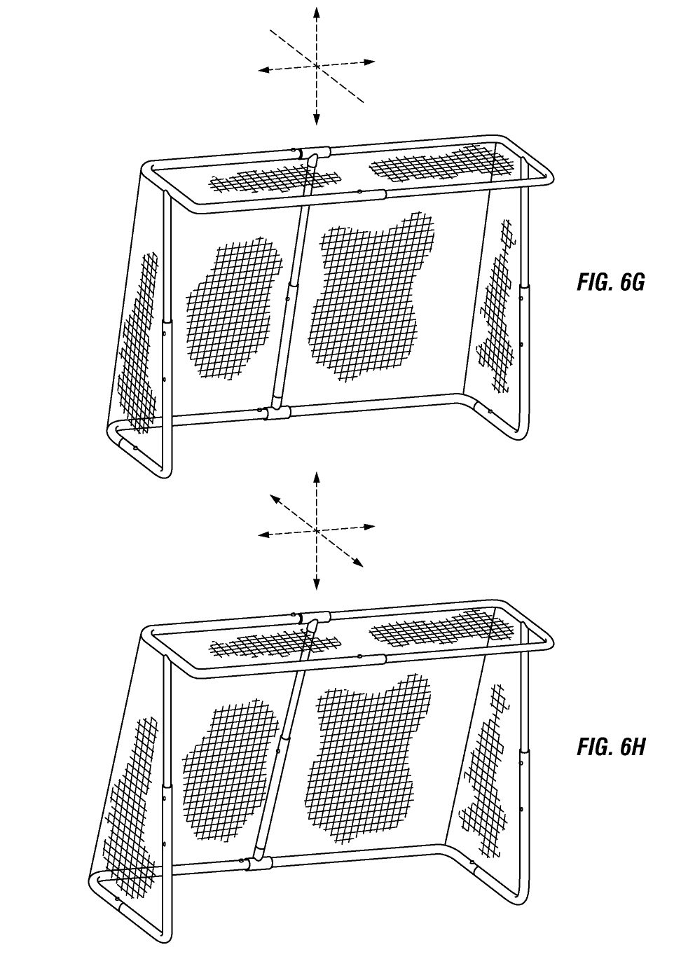

FIG. 1 displays an exploded view of a preferred embodiment of the disclosed device 10 which is collapsible in two directions along both the vertical axis V and horizontal axis H. By comparison, FIG. 1B displays an exploded view of an alternate embodiment of the device 10 wherein such is collapsible in three directions along the vertical V, longitudinal L, and horizontal H axises. As discussed later in connection with FIGS. 3 and 6A through 6H, the device 10 in either embodiment is collapsible to a collapsed position to just over ½ its expanded size (by volume) thereby making it very easy to set up and to collapse later for storage. As discussed below in more detail, collapsibility is accomplished via telescopic means at strategic positions around the supporting structure of the device 10. Of course additional smaller members making up the various telescopic components may make the device 10 collapsible to a smaller collapsed position and such is anticipated. The current preferred mode typically collapses along its axises via two telescoping components, for simplicity and to avoid the problems inherent to more moving parts.

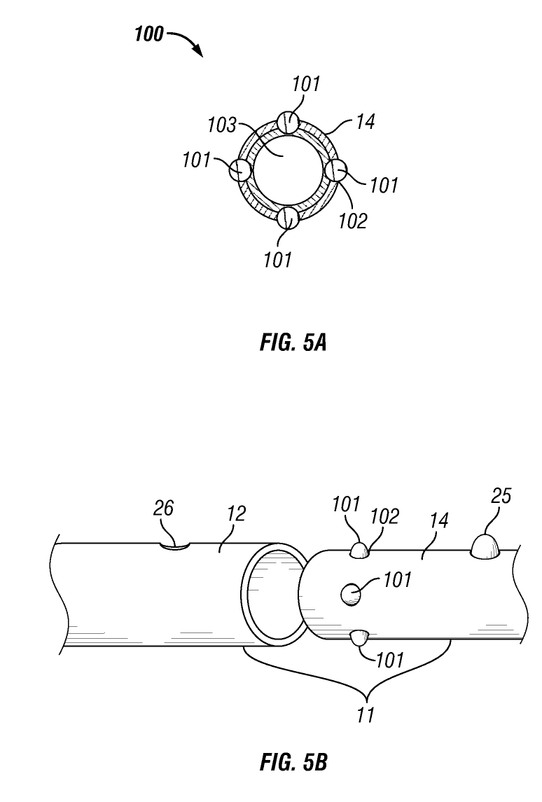

FIGS. 2 and 3 depict the assembled device 10 of FIGS. 1A and 1B. The device 10 is fully expanded in FIG. 2 and vertically V collapsed for contrast in FIG. 3. By comparing FIGS. 1A and 1B with FIGS. 2 and 3, the assembly and operation of the device 10 is disclosed. Common to all the preferred embodiments depicted in FIGS. 1A through 3, the horizontal 11, 18, 32, central 38, longitudinal 19, and vertical support members 20, 27 forming the device 10 feature telescopic engagements to allow the device 10 to translate from an expanded position (as displayed in FIGS. 2 and 6H) to a collapsed position (as illustrated in FIG. 3 but best depicted in FIGS. 6A through 6G) without the need for any disassembly of the device 10. This provides easy set up, removal from a field, and storage or transport of the device 10 in a confined area like a trunk of a vehicle.

As shown in FIGS. 1A-3 the general supporting structure of the goal 10 is preferably defined by: at least one upper or horizontal net support member 11; at least one lower horizontal base support member 18; preferably two longitudinal base support members 19; a central support member 38; and, two vertical support members 20, 27. The stated horizontal members 11, 18 are usually united by a first bended vertical support member 20/longitudinal support member 19 assembly and a second bended vertical support member 27/longitudinal member 19 assembly, whereby the bended assemblies are substantially perpendicular or normal to both of said horizontal members 11, 18, as seen in the drawings.

Still referring to FIGS. 1A-3, a pair of longitudinal base supports 19 in the form of struts are engaged to distal ends of the vertical support members 20 and 27 and rearward away from the goal opening 44 which is defined by the two vertical members and the first horizontal net support member 11. In a slightly lighter weight embodiment of the device, the two struts 19 could solely provide ground support to the device 10. However the preferred mode of the device in all embodiments has the aforementioned base support member 18 extending from a connection between the rearward distal ends of the struts 19.

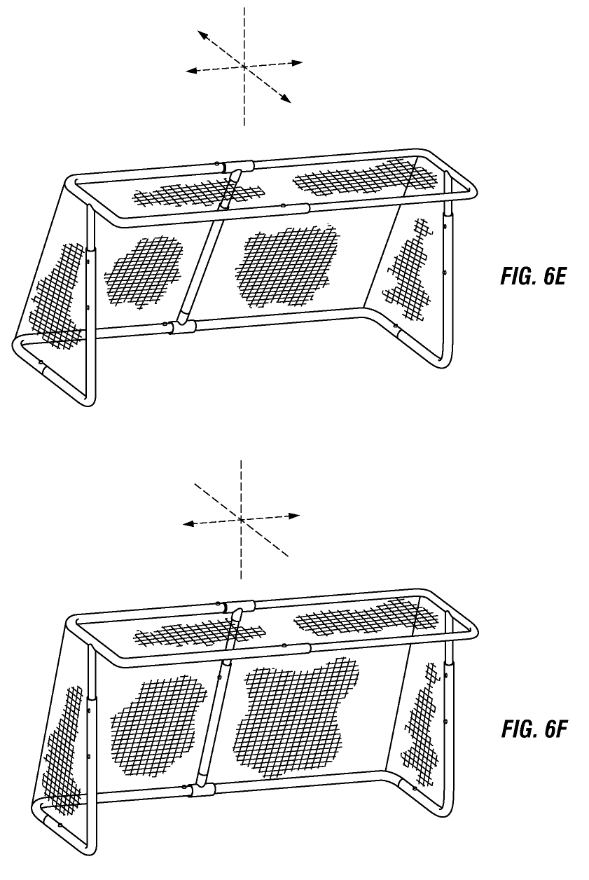

Still referring to FIGS. 1A-3 the upper horizontal net support member 11 is formed from receiving a plurality of at least two telescopically engaged components shown as receiving member 12 and a translating member 14, with the receiving member 12 having an interior axial cavity adapted to allow the translating member 14 to telescope therein; and, the translating member 14 fitted with a bearing system 100 which, as discussed below in connection with FIG. 5, rollably interacts with the internal axial cavity of the receiving member 12 when the two members 12, 14 are engaged. Likewise, the base support member 18 features translating member 16 and receiving member 17, the translating member 16 fitted with a bearing system 100. Finally, the longitudinal base support member 19 may feature a translating member 15 with bearing system 100 and receiving member 21, as depicted in FIGS. 1B and 2 for three-dimensional collapsing, or member 19 may be monadical as depicted in FIGS. 1A and 3 for two-dimensional collapsing.

Also depicted in FIGS. 1A through 3, the first vertical support member 20 is formed in a similar configuration of a plurality of at least two components shown as a receiving member 22 portion telescopically engaging over a translating member 24 featuring a bearing system 100 (see FIG. 5) Also, in a similar operational configuration the second vertical support member 27 is formed in at least two components with a receiving member 28 adapted for telescopic engagement over the translating member 30 featuring a bearing system 100 (see FIG. 5).

Further shown by FIGS. 1A-3, in the favored embodiments herein is a second horizontal net support member 32 formed of a plurality of at least two components in the form of a receiving member 34 and translating member 36 portion featuring bearing system 100. The second horizontal net support member 32, if employed as shown in all the favored embodiments, would be engaged with struts 33 in such a fashion as to position the second net support member 32 substantially parallel with the first net support member 11. It has been found through experimentation that this second horizontal net support member 32 provides a much more stable and rigid device 10 when in the expanded position and it is thus desirable to include it in the preferred mode of the device 10.

Optionally, as shown in the FIGS. 1-3 and 6A-6H, a center support member 38 may also be employed for extra strength and rigidity of the device 10 when deployed. This component is included in the preferred mode of the device 10 and would operate in a similar fashion to all the other telescoping members 11, 18, 19, 20, 27, 32 forming the device 10. More specifically, the center support member 38 is formed from at least two telescopic components shown as a receiving member 42 portion of the center support member 38 would translatably engage with a translating member 40 portion featuring a bearing system 100. At least one distal end of the center support member 38 is preferably rotationally engaged using a collar 43 that rotates on its engagement to the respective horizontal member on which it is engaged (usually either horizontal member 32 and base support member 18) to allow for easy transition to a vertically V collapsed position. If both ends are engaged with such a collar 43, the center support member 38 will still supply the added angled support while allowing the support member 38 to telescope for collapsing the device 10 vertically.

FIGS. 2 and 3 depict the device 10 as would be assembled from the depicted parts of FIGS. 1A and 1B into a goal support 10 for a net, by sliding the respective vertical 24, 28, horizontal 14, 16, 36, and longitudinal 15 translating members into an engagement with the respective receiving members. In the case of all support members 11, 18, 19, 20, 27, 32 a means for locking the translating portion 14, 16, 15, 24, 28, 36 into position within the receiving portion 12, 17, 21, 24, 30, 34 of the respective members 11, 18, 19, 20, 27, 32 may preferably be employed as a means to maintain the device 10 in an expanded position for use.

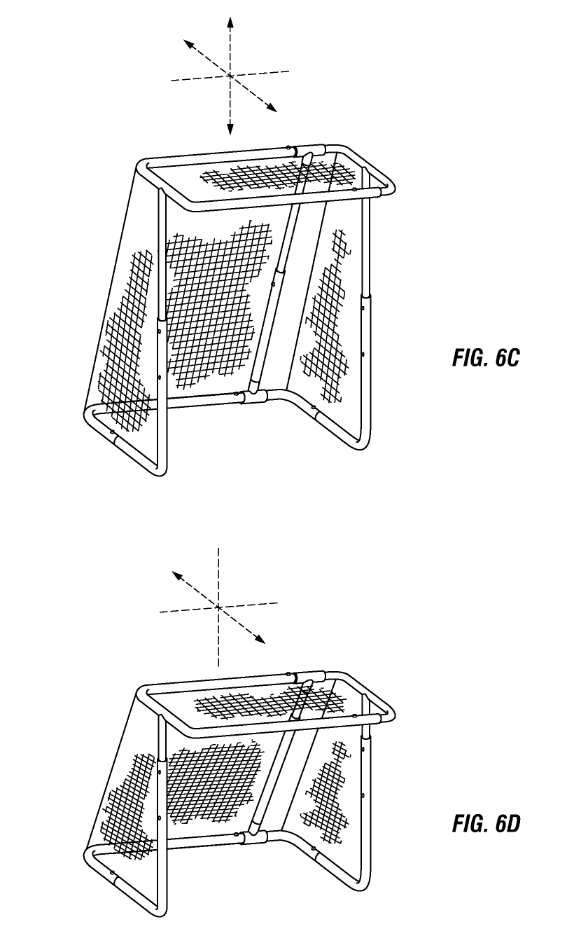

FIG. 4 provides an illustration of such a means for locking the two portions of the support members 11, in an expanded position. For example the translating portion 14 and receiving portion 12 of the support member 11 as depicted in the figure, may be an outwardly biased pin 25 which is finger depressible, and which will preferably engage into apertures 26 formed in the wall of the receiving member 12. The pin 25 would be depressed with a finger until the translating portion 14 slides into the receiving portion 12. The pin 25 would then pop out of the aperture 26 when the translating portion 12 is aligned to allow such.

Although FIG. 4 depicts the translating 14 and receiving 12 members of net support member 11 as an example, locking the other support members 18, 19, 20, 27, 32, can be achieved using the same means for locking the two portions of the respective members in a registered engaged position noted above with the depressible pin 25 operatively protruding from the wall of the respective translating members 16, 15, 24, 28, 36 and one of a plurality of apertures communicating through the wall of the respective receiving members 17, 21, 24, 30, 34.

FIGS. 5A and 5B depict an example of the bearing system 100 featured on the translating members within the structure of the goal 10, with the translating member 14 of the horizontal support member 11 being depicted as an example. FIG. 5A is a cross section of FIG. 5B. The bearing system 100 is defined by a plurality of radially spaced beads 101 rollably positioned within the surface of the translating member 14 at the telescoping end, whereby a small profile of the bead 100 depressibly extends radially distal to the surface. A preferable method for accomplishing the bearing system 100 in a support structure featuring tubular translating members, for example the translating member 14, is depicted in FIGS. 5A and 5B. As seen in these figures, the bearing system 100 may be provided to the translating member 14 by drilling diametrically aligned holes 102 circumferentially through the translating member 14, inserting a core 103 beneath said holes 102, and placing the ball 101 into the hole whereby the core 103 props the ball 101 to provide a profile above the surface. The core 103 also provides flexibility whereby pressure on the ball 101 will result in depression within the core 103. Furthermore, the ball 101 may freely roll within the hole 102 on top of the core 103. Friction is reduced during telescoping of the translating member 14 and the receiving member 12 via the ball 101 contacting the internal axial wall of the receiving member 12 and rolling therealong while the inserting member 14 translates between telescopic positions. Although the figure depicts translating member 12 and receiving member 14, the same method could be used for providing a bearing system 100 to the other translating members of the device 10.

The device 10 as shown and described would thus be easily stored in the collapsed position where it would occupy substantially less than 60% of its volumetric size in the expanded position where it would be used for a game with the net attached. Transition from the collapsed position to the expanded position, and back, is easily accomplished without the need to disassemble any of the various horizontal and vertical members forming the device 10 since they are all respectively telescopically engaged and substantially perpendicular to each other. The user simply needs to disengage the means to hold the components of the device 10 in the expanded position and collapse the device in at least two planes to the smaller collapsed position. Once so collapsed it is easily stored or transported. An additional benefit of not having to separate the parts to collapse the device 10 is provided by the fact that the goal net may remain attached during storage in the collapsed position since none of the various members forming the device 10 need be removed or disengaged.

FIGS. 6A-6H diagram a few configurations of the goal 10, attainable via selective telescoping of the support structure. More specifically, in the figures: configuration 6A is a goal 10 collapsed in all planes and represents a reference for all the other depicted configurations; 6B has been expanded vertically from 6A; 6C has been expanded vertically and longitudinally from 6A while 6D has only been expanded longitudinally therefrom; 6E has been expanded longitudinally and horizontally from 6A, but 6F has only been expanded horizontally; 6G has been expanded horizontally and vertically from 6A; and, 6H has been expanded in all three planes. Although partial telescopic expansion exists which would result in a configuration in between the depicted configurations 6A-6H, the depicted configurations 6A-6H illustrate the goal's 10 ability to telescope in any of the planes independent to the particular telescopic configuration of the device 10 within the other planes. For example: the configuration of FIG. 6A can be manipulated to the configuration of FIG. 6F without manipulating the device 10 in the vertical or longitudinal axises; the configuration of FIG. 6A can be manipulated to the configuration of FIG. 6B without manipulating the device 10 in the horizontal or longitudinal axises; and, the configuration of FIG. 6A can be manipulated to the configuration of FIG. 6D without manipulating the device 10 in the vertical or horizontal axises. Also for example, the fully expanded configuration of FIG. 6H may be reduced to FIG. 6A via collapse from: 6H to 6G, 6G to 6B, 6B to 6A; 6H to 6G, 6G to 6F, 6F to 6A; 6H to 6C, 6C to 6B, 6B to 6A; 6H to 6C, 6C to 6D, 6D to 6A; 6H to 6E, 6E to 6F, 6F to 6A; or, 6H to 6E, 6E to 6D, 6D to 6A.

Although the invention has been described with respect to particular embodiments thereof, it should be realized that various changes and modifications may be made therein without departing from the spirit and scope of the invention. While the invention as shown in the drawings and described in detail herein discloses arrangements of elements of particular construction and configuration for illustrating preferred embodiments of structure and method of operation of the present invention, it is to be understood, however, that elements of different construction and configuration and other arrangements thereof, other than those illustrated and described, may be employed in accordance with the spirit of this invention. Any and all such changes, alterations and modifications, as would occur to those skilled in the art, are considered to be within the scope of this invention as broadly defined in the appended claims.

Further, the purpose of the attached abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

A sports goal comprising: a support frame operationally configured to telescope in the vertical, horizontal, or longitudinal planes; and, said operational configuration to telescope defined by at least one receiving member, and at least one translating member featuring a bearing system.

A collapsible sports goal comprising: at least one support structure operationally configured to electively telescope in the vertical, horizontal, or longitudinal dimensions according to user preference; said frame further operationally configured to electively telescope in the vertical dimension; said frame further operationally configured to electively telescope in the longitudinal dimension; said frame further operationally configured to telescope in the horizontal dimension; and, any of said operational configurations to telescope defined by at least one receiving member, and at least one translating member featuring a bearing system in telescopic engagement.

A method of manipulating a collapsible sports goal comprising the steps of: obtaining a collapsible sports goal with at least one support member, said support member comprising a translating member and a receiving member; gripping said support member; and, rolling a ball disposed in said translating member along the inner wall of said receiving member.

I claim:

1. A sports goal comprising:
a support frame operationally configured to telescope in the vertical, horizontal, or longitudinal planes; and,
said operational configuration to telescope defined by at least one receiving member, and at least one translating member featuring a bearing system.

2. The sports goal of claim 1 further comprising:
at least one locking mechanism operationally configured to electively prevent the telescope of said goal in said vertical, horizontal, and longitudinal planes.

3. The sports goal of claim 1, wherein said bearing system features:
at least one ball positioned to depressibly roll within said translating member and against said receiving member whereby telescopic friction between said receiving and translating members is reduced.

4. The sports goal of claim 3, wherein said bearing system further features a core beneath said ball.

5. The sports goal of claim 2 wherein said bearing system features:
at least one ball positioned to depressibly roll within said translating member and against said receiving member whereby telescopic friction between said receiving and translating members is reduced.

6. The sports goal of claim 3 further comprising a net.

7. The sports goal of claim 2 further comprising a net.

8. The collapsible sports goal of claim 1 wherein elective telescoping of said frame in said vertical, said horizontal, or said longitudinal dimension may result in any at least five possible independent volumetric sizes.

9. A collapsible sports goal comprising:
at least one support structure operationally configured to electively telescope in the vertical, horizontal, or longitudinal dimensions according to user preference;
said frame further operationally configured to electively telescope in the vertical dimension;
said frame further operationally configured to electively telescope in the longitudinal dimension;
said frame further operationally configured to telescope in the horizontal dimension; and,
any of said operational configurations to telescope defined by at least one receiving member, and at least one translating member featuring a bearing system in telescopic engagement.

10. The collapsible sports goal of claim 6 wherein:
Said configuration to electively telescope in the horizontal dimension is a accomplished via said frame featuring at least one upper horizontal support member formed of at least one receiving member, and at least one translating member featuring a bearing system, in telescopic engagement, and at least one lower horizontal base support member formed of at least one receiving member, and at least one translating member featuring a bearing system, in telescopic engagement;
said configuration to electively telescope in the vertical dimension is a accomplished via said frame featuring at least one vertical member formed of at least one receiving member, and at least one translating member featuring a bearing system, in telescopic engagement, and at least one center support member formed of at least one receiving member, and at least one translating member featuring a bearing system, in telescopic engagement, wherein one of said components members of said center support is pivotably engaged with one of said upper horizontal support members and the other of said component members of said center support is pivotably engaged with one of said lower horizontal base support members; and,
said configuration to electively telescope in the longitudinal dimension is a accomplished via said frame featuring at least one longitudinal base support member formed of at least one receiving member, and at least one translating member featuring a bearing system, in telescopic engagement, and at least one center support member formed of at least one receiving member, and at least one translating member featuring a bearing system, in telescopic engagement wherein one of said components members of said center support is pivotably engaged with one of said upper horizontal support members and the other of said component members of said center support is pivotably engaged with one of said lower horizontal base support members.

11. The collapsible sports goal of claim 10 further comprising:
at least one net, engaged on said frame.

12. The collapsible sports goal of claim 11 further comprising:
At least one locking means to prevent telescopic expansion or retraction of said frame in any of said dimensions.

13. The collapsible sports goal of claim 12 wherein elective telescoping of said frame in said vertical, said horizontal, or said longitudinal dimension may result in any at least five possible independent volumetric sizes.

14. A method of manipulating a collapsible sports goal comprising the steps of:
obtaining a collapsible sports goal with at least one support member, said support member comprising a translating member and a receiving member;
gripping said support member; and,
rolling a ball disposed in said translating member along the inner wall of said receiving member.

15. The method of claim 14 wherein said rolling is accomplished depressibly.

16. The method of claim 14 further comprising the step of locking the support member after the step of rolling a ball disposed in said translating member along the inner wall of said receiving member.

17. The method of claim 14 further comprising the step of unlocking the support member before the step of rolling a ball disposed in said translating member along the inner wall of said receiving member.

18. The method of claim 14 wherein said rolling is accomplished in the vertical dimension.

19. The method of claim 14 wherein said rolling is accomplished in the horizontal dimension.

20. The method of claim 14 wherein said rolling is accomplished in the longitudinal dimension.
